(19) United States
(12) Patent Application Publication
(10) Pub. No.: US 2010/0236075 A1
(43) Pub. Date: Sep. 23, 2010

(54) Scraping utensil and means for storing a utensil

(76) Inventor: Richard Lambert, Kleinberg (CA)

Correspondence Address: R. Neil Sudol, 714 Colorado Avenue, Bridgeport, CT, 06605-1601, US

(21) Appl. No.: 12/661,274

(22) Filed: Mar. 12, 2010

Related U.S. Application Data
(60) Provisional application No. 61/159,987, filed on Mar. 13, 2009.

(51) Int. Cl. B26B 11/00; B26B 3/00

(52) U.S. Cl. 30/138; 30/169

(57) ABSTRACT

A kitchenware utensil composed of fibreglass reinforced polyphenyl sulfide PPS is provided. In particular, a kitchenware scraper and an improved scraper blade, composed of PPS are described. The invention also provides a stand for storing the scraper in an upright position, and an abrasive apparatus for reshaping or sharpening the scraper.

### TECHNICAL FIELD

The claimed invention relates to the field of kitchenware utensils, and more particularly to scrapers.

### BACKGROUND

Cooking surfaces, such as pots, pans, grills, stove tops, and pizza stones, and food preparation surfaces such as chopping boards, counters and kneading surfaces, typically require cleaning. Cleaning may involve the removal of burned or stuck food particles from the surface that must be removed through the application of force and the use of some cleaning tool.

These cooking and food preparation surfaces may have different contours or configurations. For example, countertops and pizza stones have substantially flat, smooth surfaces, while the surface of grills or grilling pans are typically ridged, corrugated, or perforated. Pots and pans are typically provided with a sidewall forming an angle with the interior cooking surface of the pot or pan, and food particles may collect in the angle between the cooking surface and the sidewall. Different surfaces, therefore, may require differently shaped cleaning tools.

It is therefore desirable to provide an improved cleaning implement, such as a scraper. It is further desirable to provide a base or support for holding the cleaning implement when not in use.

### BRIEF DESCRIPTION OF THE DRAWINGS

In drawings which illustrate by way of example only a preferred embodiment of the invention,

FIG. 1 is a perspective view of a scraping implement.

FIG. 2 is a top plan view of a scraping implement.

FIG. 3 is a partial view of the blade of the scraping implement of FIG. 2.

FIG. 4 is a partial perspective view of a scraping implement blade on a ridged grilling surface.

FIG. 5 is a side view of a stand for the scraping implement.

FIG. 6 is a perspective view of a base and its openable lid.

FIG. 7 is a side view of a package for displaying and storing a scraper.

### DETAILED DESCRIPTION

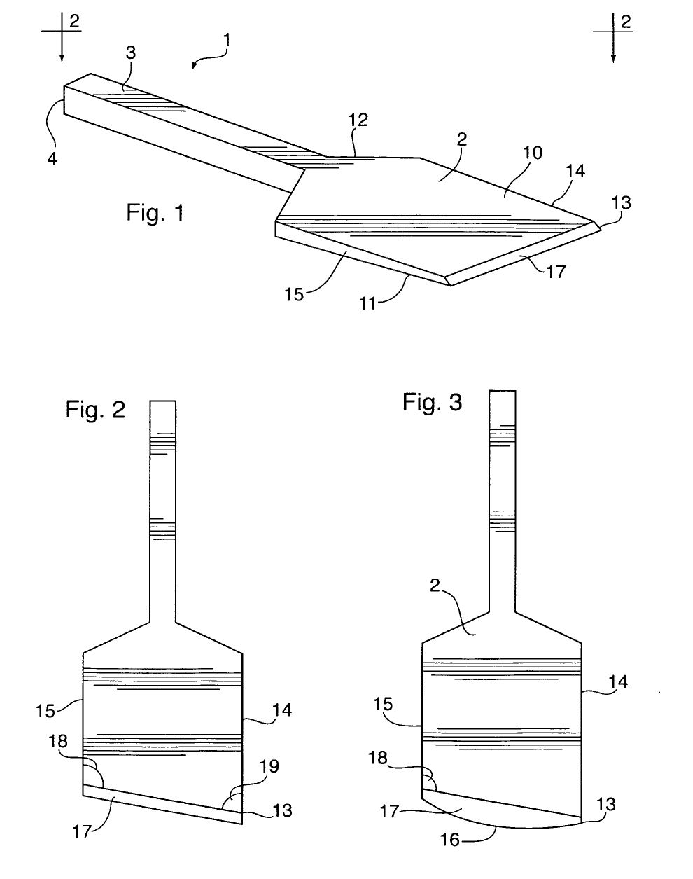

Referring to FIG. 1, a scraping implement 1 comprising a blade or spatula 2 and a handle 3 is provided. The blade comprises a first surface 10 and an opposing surface 11, a handle end 12, and a distal end 13. The handle end 12 may be integrally formed with the handle 3. The first side 14 and opposing second side 15 of the blade 2, as shown in FIG. 1, may be substantially parallel; in other embodiments the first and opposing sides 14, 15 need not be parallel, so the width of the blade 2, as defined by the distance between the first and opposing sides 14, 15, may be narrower near the handle end 12 than near the distal end 13 of the blade 2. The first surface 10 and the opposing surface 11 may be substantially parallel to each other, although in some embodiments the blade 2 may be tapered towards the distal end 13, such that the thickness of the blade 2, as defined by the distance between the first and opposing surfaces 10, 11 is greater near the handle end 12 than near the distal end 13 of the blade 2.

The distal end 13 of the blade 2 may be provided with a bevelled edge 17 to facilitate the use of the scraping implement by providing an acute angle between the opposing surface 11 and the bevelled edge 17. In one embodiment, as shown in FIG. 3, the opposing surface 11 is substantially flat and the bevelled edge 17 is further provided with an arc or camber 16, such that the central portion of the bevelled edge 17 of the blade 2 extends further than the first and opposing sides 14, 15. It has been found that the provision of a slight arc or camber in the profile of the bevelled edge 17 helps reduce snagging of the blade 2 on food particles or surface features as the cambered, bevelled edge of the scraping implement 1 is used to clean a surface. As depicted in FIG. 2, one of the first or second sides 14, 15 may be longer than the other, thus defining an acute angle 18, 19 that may be useful in cleaning certain angled regions in cooking surfaces, such as the interior corners of pots or pans.

Returning to FIG. 1, the handle 3 of the scraping implement 1 may be provided in any suitable shape or length. In one embodiment, the total length of the blade 2 and handle 3 is between about 18 cm and 25 cm long, so that the scraping implement 1 may be used with one hand. A user may grip the handle 3 at an intermediate point at or near the handle end 12 of the blade 2, and the end of the handle, mounting end 4, may rest against the palm of the user's hand. The mounting end 4 may be provided with a rounded end to fit within the user's cupped palm. Thus, in use, the user may apply force both downward and forward on the scraping implement 1 by both bearing down on the implement 1 near the handle end 12 and by pushing forward on the mounting end 4.

It has been discovered that polyphenylene sulfide (PPS) compounds are particularly useful in the manufacture of utensils such as the scraping implement described above. PPS is a thermoplastic polymer comprising alternating sulphur atoms and phenylene rings in a para substitution pattern. The polymer is known for its high strength, thermal and dimensional stability, abrasion resistant and chemical resistant properties.

Suitable PPS compounds are widely available from different manufacturers, and can be moulded using conventional moulding equipment. In particular, R-4-200, a 40% fibreglass reinforced PPS compound, sold by Chevron Phillips Chemical Company LP, P.O. Box 4910, The Woodlands, Tex., U.S.A. 77387-4910 under the Ryton™ brand, has been found to be a useful PPS compound for manufacturing kitchenware utensils. This particular PPS compound will not deform when contacting surfaces up to 500° F. and is flame resistant. Accordingly, utensils made of this PPS compound are suitable for use on cooking surfaces and open flame grills.

The inherent properties of PPS provide for the manufacture of a utensil having low thermal conductivity, resistance to deformation and degradation despite repeated exposure to high temperatures, and enhanced strength and toughness. Such utensils are particularly useful when handling or working with hot cookware or surfaces.

Since PPS has low thermal conductivity, little heat will be transferred from a cooking surface to the handle 3 of the scraping implement described above. Thus, in another embodiment the blade 2 of the scraping implement 1 is formed from a PPS compound. In a further embodiment, the handle 3 and the blade 2 are integrally formed from PPS. An integral construction of the scraping implement 1 using PPS provides increased strength and rigidity to the utensil, allowing for more force to be applied to the scraping implement 1 when cleaning or scraping a cooking or food preparation surface, without deforming or damaging the scraping implement 1.

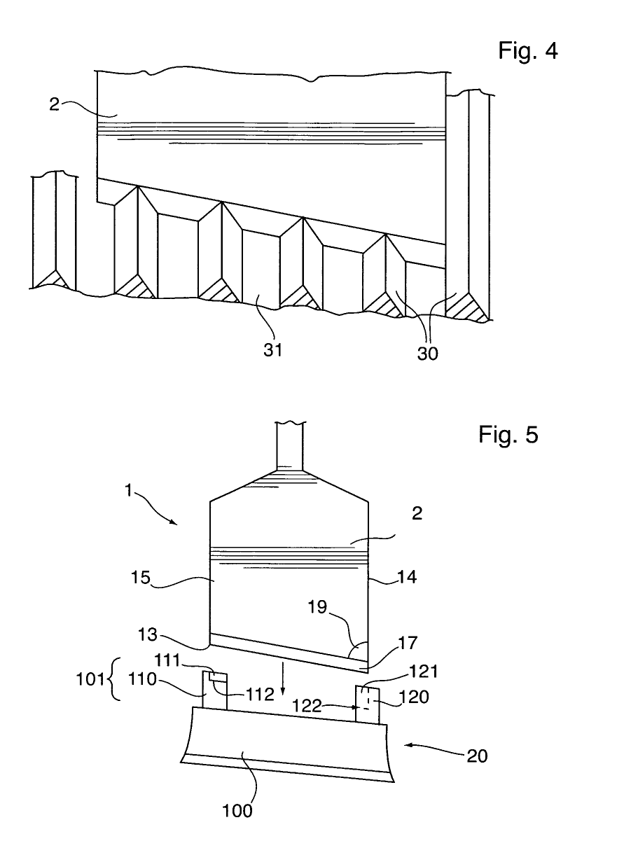

The scraping implement 1 may be manually shaped and reshaped by the user to provide varying angles or curves along the various edges or surfaces of the blade 2. For example, the user may shape the bevelled edge 17 to provide a sharper or duller bevel angle, or may smooth or sharpen the angle 19 defined by the bevelled edge 17 and the second side 15 so that the scraping implement 1 fits more easily in the angles or surface contours of a cooking or food preparation surface. In addition, the arc 16 of the bevelled edge 17 may be reshaped. Referring to FIG. 4, the blade 2 of a scraping implement 1 is shown with a contoured edge shaped to accommodate the ridges 30 of a grilling surface 31. In addition or alternatively, the handle 3 may also be manually shaped or reshaped to conform to the user's preferred method of gripping the scraping implement 1, for example to provide or enhance a convex area on the handle 3 corresponding to a position of the user's thumb when gripping the implement 1. In particular, where the blade 2 and/or handle 3 is formed of PPS, it may be sharpened or reshaped using a common, inexpensive abrasive or shaping apparatus, such as a sheet of sand paper, a file, burr, or rasp, a ridged, hardened metal (such as, but not limited to, hardened steel) surface, or a natural or manufactured sharpening or honing stone comprising materials including, but not limited to, natural stone, ceramic, and diamond material bonded to a substrate.

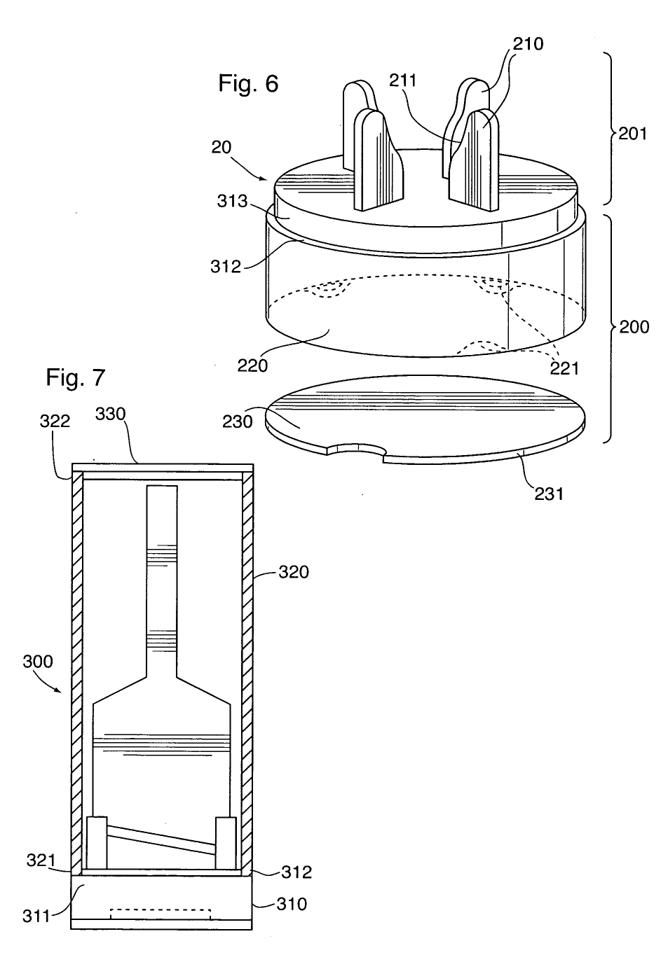

Referring to FIGS. 5 and 6, a stand 20 for holding the scraping implement 1 is provided. The stand 20 allows the scraping implement to be stored in a substantially vertical position. The stand 20 comprises a base 100 for resting on a substantially flat surface, such as a countertop or table, and a seat 101 for receiving the scraping implement 1. The base 100 may be formed or manufactured from a variety of materials, including PPS, or any other suitable material such as plastics, metals such as stainless steel or aluminum, or natural materials such as wood, marble, or other stone, and the like. The base may be circular, elliptical, square, or rectangular in shape, or it may take any other shape that provides sufficient stability.

In a first embodiment, the base 100 may be substantially solid so as to provide additional stability. In a further embodiment, a base 200 may include an opening or receptacle, discussed below.

Referring to FIG. 5, the seat 101 comprises at least one support means 110 extending from the base 100. The support means 110 may be formed integrally with the base 100, or may be manufactured as a separate component and fixedly attached to the base 100. The support means 110 includes a channel 111 shaped to receive either the first or the second side 14, 15 of the blade 2. The channel 111 may be an open bore in the support means 110 extending through the entire length of the support means 110 extending from the base 100, or it may terminate at a shoulder 112. The blade 2 may then be inserted into the channel 111 so that the corresponding side 14, 15 is held within the channel 111, with the end of the side 14, 15 resting on the shoulder 112 or on the base 100 directly. In one embodiment, a second support means 120 is provided with a channel 121, shaped to receive the remaining side 15, 14 of the blade 2. The channel 121 may terminate at a shoulder 122 which, depending on the configuration of the blade 2 of the scraping implement 1, may be provided at the same height above the base 100 as the first shoulder 112, or may be provided at a different height. For example, if the bevelled edge 17 of the blade 2 is oriented so as to provide an acute angle 19 defined by the side wall 14 and the bevelled edge 17, wherein the side wall 14 is longer than the other side wall 15, the channel 121 corresponding to the first side 14 may be deeper (for example, the shoulder 122 may be disposed closer to the base 100) than the channel 111 shaped to receive the second side 15. The dimensions of the first and second support means 110, 120 may be sized to provide an interference fit with the blade 2.

Turning to FIG. 6, in an alternative embodiment the seat 201 of a base 200 may comprise handle support means 210 configured to receive the mounting end 4 of the handle 3, wherein each of the handle support means 210 is shaped to receive a portion of the mounting end 4. In the example depicted in FIG. 6, a plurality of handle support means 210 are provided in a “claw-like” configuration and are shaped to receive the mounting end 4 of the handle 3, such that the mounting end 4 rests on a shoulder 211 of each handle support means 210.

As explained above, the base 100 or 200 may be a solid form. The base 100 or 200 may be manufactured from a medium used for shaping the scraping implement 1, for example a sharpening stone material. The base 100 or 200 may also include at least one external surface provided with a shaping surface, for example one side of the base 100 or 200 may be provided with a sandpaper surface (e.g., sandpaper may be adhered to a surface of the base 100 or 200).

In a further embodiment, the base 100 or 200 may include an opening or receptacle. In FIG. 6, the base 200 comprises a container portion 220 and a removable cover 230. The cover 230 may form the surface of the base 200 that rests on a countertop or table. A groove or recess 231 extending around the perimeter edge of the cover 230 is sized to receive one or more tabs 221 extending radially inward from an inner sidewall of the container portion 220 to provide a snap fit between the cover 230 and the container portion 220. In an alternative embodiment, the cover 230 may be hingedly attached to the container portion 220 (not shown); for example, if the base 200 is made of a suitable plastic composition, the cover 230 and the container portion 220 may be integrally formed and joined with a living hinge. A shaping medium, such as sandpaper or a sharpening stone, may be concealed inside the container portion 220. The base 200, including one of the container portion 220, the cover 230, or both, may be weighted to improve the stability of the base 200.

It will be apparent to a person skilled in the art that a stand 20 can be formed using any of the features described above, with respect to the base or seat. For example, one possible configuration of the stand 20 may comprise the base 200 having an opening, wherein the cover 230 is made of a shaping medium, and the seat 100, configured to receive the blade 2 of a scraping implement 1.

Turning to FIG. 7, packaging 300 for displaying and marketing the scraper implement 1 is provided through cooperation of a stand 310 and a sidewall 320, such that the stand 310 may be used to store the scraping implement 1 without the sidewall 320. The sidewall 320 can be transparent, translucent, or solid and could be printed or formed with indicia suitable for marketing purposes. The stand 310 includes a flange (not shown) or a shoulder 312 extending around at least a portion of the perimeter of its base 311, having a shape corresponding to a first end 321 of the sidewall, to support the sidewall 320. FIG. 6 depicts the shoulder 312 extending around the entire perimeter of the base 200. The sidewall 320 may be removably attached to the base 311 through an interference fit between an upper sidewall surface 313 of the base 311 and an interior face of the sidewall 320. In a further embodiment, the base 311 may have an annular or perimeter bead which cooperates with a corresponding recess in the sidewall 320 to provide a snap fit. Alternatively, the base 311 may include a helical groove to engage a corresponding thread disposed on the inner surface of the sidewall 320, or vice versa. A lid 330 cooperating with a second end 322 of the sidewall 320 may be used to close the packaging 300. The lid 330 may use any of the means for cooperation with the sidewall 320 as the stand 310. In a further embodiment, the lid 330 comprises a second stand to engage the respective distal 13 or mounting end 4 not engaged by the stand 310. In an alternative, the sidewall 320 may extend to provide an integral cover for the packaging, without the need for a separate lid 330. The packaging 300 may also enclose a shaping medium, which may be conveniently located in the container portion of base 311.

Various embodiments of the present invention having been thus described in detail by way of example, it will be apparent to those skilled in the art that variations and modifications may be made without departing from the invention. For example, in further embodiments the implement 1 may be provided with an angled handle 3, such that when the blade 2 is held substantially flush on a surface, the mounting end of the handle 4 extends upwards from the surface. The angle may be provided at or near the junction of the blade 2 with the handle 2. Alternatively, the handle 3 may be provided with a dogleg or double angle so as to offset the axis of the handle 3 near the mounting end 4 from the plane of the blade 2. The blade 2 may be rounded or cupped so as to be usable as a spoon or scoop, or in a further alternative may be generally rounded in shape for use as a spreader, with or without one or more serrated edges.

1. A kit comprising:
a scraping implement comprising a blade and a handle; and
a shaping medium for reshaping at least one of the blade and the handle of the scraping implement.

2. The kit of claim 1, wherein the blade comprises a polyphenyl sulfide compound.

3. The kit of claim 1, wherein the handle comprises a polyphenyl sulfide compound.

4. The kit of claim 2, wherein the blade and handle are integrally formed of the polyphenyl sulfide compound.

5. The kit of claim 2, wherein the polyphenyl sulfide compound comprises fibreglass.

6. The kit of claim 5, wherein the polyphenyl sulfide compound comprises about 40% fibreglass.

5. (canceled)

6. (canceled)

7. The kit of claim 6, wherein the shaping medium is selected from the group of: sandpaper, a natural or manufactured sharpening stone, a file, a burr, a rasp, and a ridged and hardened metal surface.

8. The kit of claim 6, wherein the stand comprises a plurality of handle supports for receiving the handle of the scraping implement, such that the scraping implement is supported in a substantially vertical orientation.

9. The kit of claim 7, wherein the shaping medium is comprised in a container portion of the stand.

10. The kit of claim 9, wherein the stand container portion is partially defined by a removable cover.

11. The kit of claim 6, wherein the shaping medium is provided on an external surface of the stand.

12. The kit of claim 6, wherein the stand is formed from the shaping medium, and the shaping medium comprises a natural or manufactured sharpening stone material.

13. A scraping implement comprising a blade composed of a polyphenyl sulfide compound.

14. The scraping implement of claim 13, further comprising a handle composed of the polyphenyl sulfide compound.

15. The scraping implement of claim 14, wherein the blade and the handle are formed integrally.

16. The scraping implement of claim 13, wherein an end of the blade comprises a cambered edge.

17. The scraping implement of claim 16, wherein the cambered edge is bevelled.

18. The scraping implement of claim 14, wherein the combined length of the blade and handle is between 18 and 25 centimetres.

19. The scraping implement of claim 13, wherein the polyphenyl sulfide compound comprises about 40% fibreglass.

20. The kit of claim 1, wherein the shaping medium is selected from the group of: sandpaper, a natural or manufactured sharpening stone, a file, a burr, a rasp, and a ridged and hardened metal surface.

21. The kit of claim 1, further comprising a stand for holding the scraping implement, the stand comprising the shaping medium.
